(19) United States
(12) Patent Application Publication
(10) Pub. No.: US 2015/0211233 A1
(43) Pub. Date: Jul. 30, 2015

(54) ROOF COVERING ELEMENT

(71) Applicant: ThyssenKrupp Steel Europe AG, Duisburg (DE)

(72) Inventors: Anna-Lena Pagadelz-Kiehl, Moers (DE); Peter Klauke, Schwerte (DE); Tobias Lewe, Munster (DE); Oliver Kleinschmidt, Dortmund (DE)

(73) Assignee: ThyssenKrupp Steel Europe AG, Duisburg (DE)

(21) Appl. No.: 14/403,642

(22) PCT Filed: May 29, 2013
(86) PCT No.: PCT/EP2013/061101

§ 371 Date: Nov. 25, 2014

(30) Foreign Application Priority Data
May 31, 2012 (DE) 10 2012 104 729.4

(51) Int. Cl. E04D 3/35; B32B 15/14; B32B 7/12; E04D 1/28

(52) U.S. Cl. CPC E04D 3/352; E04D 1/28; B32B 15/14; B32B 7/12; B32B 2262/108; B32B 2419/06; B32B 2307/304; B32B 2307/714

(57) ABSTRACT

The invention relates to a roofing element (1), consisting of a sandwich-structure material composite, which is made up of metallic outer sheets and at least one core layer arranged between the outer sheets. In order that such a roofing element has a sufficiently high temperature resistance, is relatively lightweight, stable and durable and can be produced at relatively low cost, according to the invention the core layer is formed from a fibre-containing insulating material that is temperature-resistant up to at least 600° C., the thickness of the core layer being up to 2.0 mm.

The invention relates to a roofing element, consisting of a sandwich-structure material composite, which is built up of metallic outer sheets and at least one core layer arranged between the outer sheets.

The use of corrosion-protected or corrosion-resistant metal sheets for covering the roofs of buildings has long been known. For this purpose, usually large metal sheets, which are for example produced from hot-dip galvanized steel strip in the form of trapezoidal or corrugated profiles, are fastened on battens and/or rafters of a roof structure. Normal, i.e. single-layer, metal sheets do not however offer satisfactory heat insulation or satisfactory structure-borne sound insulation.

It is also known to design metallic roofing panels in the form of sandwich panels, in order in particular to give such panels improved heat insulating properties. For this purpose, a sandwich-structure material composite is produced, made up of metallic outer sheets and a core layer of foam. For producing such a material composite, the outer sheets are usually foam-backed.

DE 298 03 111 U1 discloses a structure-borne sound insulating component for producing a roof skin, which consists of a two-dimensional metal-plastic-metal composite material. The metal layers of this composite material consist of corrosion-resistant metal sheets or are provided with at least one corrosion-resistant coating. The layer of plastic arranged between the metal sheets is made from a structure-borne sound insulating, viscoelastic plastic. The layer of plastic preferably consists of a thermoplastic material. This known component, which has a number of impressions in the form of roof pantiles and is therefore also referred to as a “metal pantile”, does have improved structure-borne sound properties, but it is disadvantageous that it has only a relatively low temperature resistance. In particular in the case of roofs that are provided with photovoltaic systems, there is the risk of roof fires, for example if such systems are improperly fitted and/or there are malfunctions. Since residential buildings and industrial buildings are increasingly being provided with photovoltaic systems, the fire risk arising as a result of improper fitting and/or malfunctions of such systems is correspondingly increasing. In order to prevent the roof structure, which is usually made of wood, from catching fire, at least for a certain time or completely, it is desirable that roofing materials produced from composite material have a sufficiently high temperature resistance.

Against this background, the present invention is based on the object of providing a component of the type mentioned at the beginning that has a sufficiently high temperature resistance, is relatively lightweight, stable and durable and can be produced at relatively low cost.

To achieve this object, a roofing element with the features of claim 1 is proposed.

The roofing element according to the invention, also referred to hereinafter as a component for producing a roof skin, is produced from a sandwich-structure material composite, which is made up of metallic outer sheets and at least one core layer arranged between the outer sheets. According to the invention, the core layer is in this case formed from a fibre-containing insulating material that is temperature-resistant up to at least 600° C., the thickness of the core layer being up to 2.0 mm.

Apart from the temperature resistance with at the same time good heat insulation, the fibre-containing core layer that is temperature-resistant up to at least 600° C., preferably up to at least 700° C., also contributes to greater stiffness properties of the component according to the invention in comparison with a conventional core layer of foam or plastic, as for example the roofing element according to DE 298 03 111 U1 has. As a result, the outer sheets of the component according to the invention can be designed to be relatively thin, so that a reduction in the weight of the sandwich material, or of the component produced from it, is also possible in comparison with the conventional design. Consequently, the component according to the invention also makes a much less complex roof structure possible, since the weight of the component according to the invention is reduced considerably not only in comparison with known concrete or clay pantiles, but also in comparison with conventional pantiles of metal-plastic-metal composite material. Moreover, on account of the fibre-containing, temperature-resistant core layer, the component according to the invention is also distinguished by good structure-borne sound insulation. Apart from the lightweight configuration of the component according to the invention, which is of advantage in particular with regard to transporting and handling the component on the building site, the component according to the invention can also, inter alia, be further processed well, for example trimmed, on the building site. As a result, the component according to the invention can be adapted quickly and flexibly to the respective conditions on site.

The component according to the invention (roofing element) fullfils at least to fire protection class A2, sometimes even fire protection class A1, in accordance with DIN 4102, if it particularly preferably has a noncombustible, fibre-containing core layer.

The thickness of the respective outer sheet of the component according to the invention lies for example in the range from about 0.1 mm to 0.8 mm, preferably in the range from about 0.1 mm to 0.5 mm, and particularly preferably in the range from about 0.1 mm to 0.4 mm.

The outer sheets of the component according to the invention are preferably produced from steel material. Steel material is a relatively low-cost material, which is distinguished by a high temperature resistance, a high breaking strength and good workability, in particular favourable deep-drawing characteristics and/or stamping characteristics.

In order to achieve favourable material costs and at the same time a long durability of the component according to the invention, a further configuration of the invention provides that the outer sheets are provided with a corrosion protection layer. The corrosion protection layer is realized for example by hot-dip treatment and/or electrolytic coating of the metallic outer sheets. Characteristic coatings for the hot-dip treatment are: Z: 99% Zn, ZA: 95% Zn+5% Al; AZ: 5% Al+43.4% Zn+1.6% Si; AS: 88-92% Al+8-12% Si.

A further advantageous configuration of the component according to the invention is characterized in that the outer sheets are of different thicknesses and/or are provided with different corrosion protection layers. As a result, an optimal roofing element with regard to high flexural strength, low component weight and high weathering resistance can be achieved.

In a further configuration of the component according to the invention, at least one of the outer sheets is provided with a corrosion protection layer formed from zinc. Alternatively or in addition, at least one of the outer sheets may also be provided with a corrosion protection layer made of aluminum.

Other coating methods that are suitable in this connection, apart from hot-dip coating and electrolytic coating, are CVD, PVD and/or sol-gel coating methods. Furthermore, the outer sheets may also be further treated, for example anodized, or such outer sheets may be used for producing the component according to the invention.

It is advantageous in particular if, according to a further configuration of the component according to the invention, at least the outer side of the upper outer sheet and/or the outer sheet facing the sun, is provided with a corrosion protection layer made of aluminum This is so because such an aluminum coating offers the component according to the invention very low absorption characteristics for solar or thermal radiation, or a high heat reflectivity.

According to a further configuration of the component according to the invention, at least the outer side of the upper outer sheet, and/or the outer sheet facing the sun, is additionally provided with an organic coating. Organic coatings in the form of lacquers may have different colours, so that there are no limits to the colouring of the component according to the invention.

To achieve a sufficiently high temperature resistance, in a further configuration of the invention the core layer or the insulating material of the core layer of the component according to the invention has a thickness in the range from about 0.6 mm to 1.5 mm, and particularly preferably in the range from about 0.7 mm to 1.3 mm.

Furthermore, it is of advantage with regard to a low component weight if, according to a further configuration of the invention, the thickness of the core layer is at least 1.5 times, preferably at least 2 times, particularly preferably at least 2.5 times, the thickness of one of the outer sheets or of the thinnest of the outer sheets.

A further advantageous configuration of the component according to the invention is characterized in that the insulating material of the core layer is produced from inorganic fibres, preferably mineral fibres, and inorganic fillers, preferably mineral fillers, in combination with organic fibres and a binder. Tests have shown that such an insulating material makes continuous operating temperatures of up to 1000° C. possible.

The insulating material or the core layer of the component according to the invention preferably contains a mineral flame retardant, which is halogen-free and acts as a smoke suppressant.

Furthermore, the insulating material or the core layer may preferably contain a fungicide, which suppresses mould formation in the core layer.

For connecting the layers of the sandwich-like material composite, a further configuration of the component according to the invention provides that the respective outer sheet is connected to the core layer by way of a layer of adhesive. A water-based adhesive, for example a polyurethane dispersion adhesive, or a heat-sealing adhesive is preferably used here as an adhesive. The layer thickness of the respective layer of adhesive is in this case for example in the range from 5 μm to 25 μm, preferably in the range from 8 μm to 15 μm. The adhesive is applied to the outer sheet for example by knife application, spraying or coating by means of an applicator roller. The outer layers (outer sheets) and the fibre-containing, temperature-resistant insulating material that is used for the core layer may be connected to one another in strip form or in panel form.

The connecting of the outer layers to the core layer is preferably performed by means of a double belt press. The adhesive applied to the outer sheet (heat-sealing adhesive) is activated in the double belt press by pressure and temperature and crosslinked with the fibre-containing, temperature-resistant core layer.

Alternatively, a water-based adhesive may already be introduced, in particular infiltrated or admixed, into the fibre-containing, temperature-resistant insulating material during the production of the insulating material or the core layer. This allows the step of applying adhesive to the outer sheets to be omitted. As already described above, the connecting of the outer layers to the core layer is preferably performed in a double belt press, in which the adhesive within the core layer is initially activated and crosslinked by pressure and temperature, and at the same time or subsequently adheres to the outer layers with a material bond.

The sandwich-like material composite according to the invention is able to undergo forming, in particular to undergo deep drawing and/or stamping, so that any desired forms can be produced, from a substantially flat plate through to three-dimensional structures of various dimensions. In particular, the component according to the invention may be formed as a pantile, shingle, corrugated profile or trapezoidal profile.

Further preferred and advantageous configurations of the component according to the invention are specified in the subclaims.

The invention is explained in more detail below on the basis of a drawing, which presents a number of exemplary embodiments and in which:

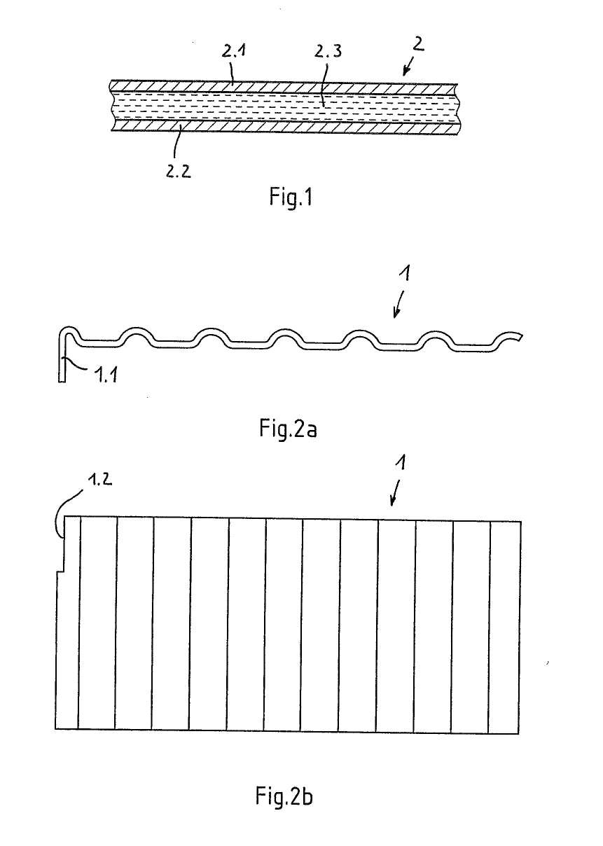

FIG. 1 shows a portion of a sandwich-structure material composite according to the invention in a sectional view;

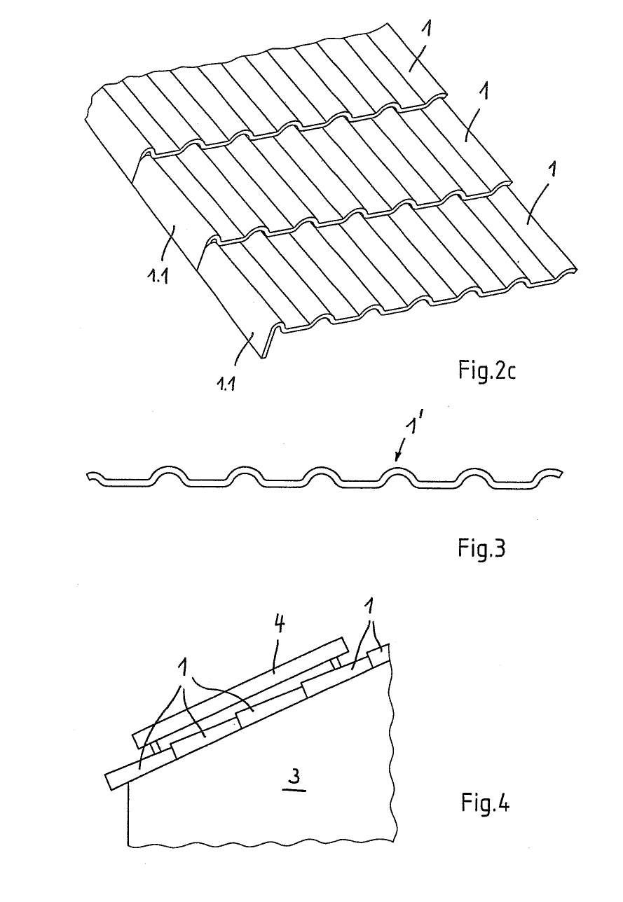

FIG. 2a shows a component having a structure in the form of a pantile for producing a roof skin, in a side view;

FIG. 2b shows the component from FIG. 2a in plan view;

FIG. 2c shows a number of components according to FIG. 2a arranged overlapping, in a perspective representation;

FIG. 3 shows a further component for producing a roof skin with a structure in the form of a pantile, in a side view; and

FIG. 4 shows a portion of a building, the roof of which is provided with a photovoltaic system, in a gable-end or side view.

The components represented in the drawing (roofing elements) 1, 1′ are formed from a sandwich-structure material composite 2. The material composite 2 is made up of two metallic outer layers 2.1, 2.2 and a fibre-containing core layer 2.3 that is temperature-resistant up to at least 600° C.

The outer layers 2.1, 2.2 consist for example of steel sheet, which is preferably provided with a corrosion protection layer. Corrosion protection layers based on zinc or aluminum are used with preference for this. The thickness of the respective outer layer (outer sheet) 2.1, 2.2 is for example about 0.1 to 0.8 mm, preferably at most 0.5 mm, particularly preferably at most 0.4 mm. In the exemplary embodiment shown in FIG. 1, both outer sheets 2.1, 2.2 have substantially the same thickness, for example about 0.3 mm, and have the same material quality. However, outer sheets 2.1, 2.2 of different thicknesses and/or material qualities may also be used for producing the material composite 2. In particular, the outer sheets 2.1, 2.2 may be provided with different corrosion protection layers. Thus, for example, the outer sheet 2.1 or 2.2 that is facing the sun after covering the roof concerned may be provided with an aluminum-based coating which has a high heat reflectivity.

The core layer 2.3 consists of a fibre-containing insulating material that is temperature-resistant up to at least 600° C., preferably up to at least 700° C., with a thickness of about 0.5 to 2.0 mm, preferably about 0.6 to 1.5 mm, and particularly preferably in the range from about 0.7 to 1.3 mm.

The material of the core layer 2.3 consists of a mixture of inorganic fibres, preferably mineral fibres, and an inorganic filler, preferably mineral fillers, with a small proportion of organic fibres and a binder. The inorganic fibres, which together with the inorganic filler make up the main constituent of the core layer material, are preferably bio-soluble mineral fibres. Furthermore, the core layer material may contain a mineral, halogen-free flame retardant, which has a high smoke-suppressing effect. Since the proportion of organic fibres and organic binder in the core layer 2.3 is very low, only a small amount of smoke develops when it is exposed to the effect of a fire or heat.

The inorganic fibres and mineral fillers of the core layer 2.3 make it possible that such a layer of insulating material withstands continuous operating temperatures of up to 900° C. or even up to 1000° C., preferably is noncombustible. Moreover, the core layer 2.3 designed in such a way has good heat insulation and good sound insulation.

Apart from the high temperature resistance with at the same time good heat insulation, the fibre-containing core layer 2.3 also offers the sandwich-structure roofing element 1, 1′ according to the invention much greater stiffness properties in comparison with a conventional core layer of plastic, as for example the pantile consisting of metal-plastic-metal composite material according to DE 298 03 111 Ul has. These greater stiffness properties make it possible for relatively thin metallic outer layers 2.1, 2.2 to be used, and consequently a reduction in the weight of the sandwich-structure roofing element 1, 1′.

It can be clearly seen in FIG. 1 that each of the outer sheets 2.1, 2.2 of the material composite 2 is formed to be considerably thinner than the core layer 2.3. To achieve a lightweight roofing element, the thickness of the core layer 2.3 is at least 1.5 times, preferably at least 2 times, and particularly preferably at least 2.5 times, the thickness of the thinnest of the two outer sheets 2.1, 2.2.

The outer sheets 2.1, 2.2 are connected to the core layer by adhesive bonding. For this purpose, for example, one side of the respective outer sheet 2.1 or 2.2, to be specific the side facing the core layer 2.3, is coated with adhesive. The adhesive is preferably a water-based adhesive, for example polyurethane dispersion adhesive. For an adequate connection of the outer sheet 2.1, 2.2 and the core layer 2.3, the adhesive is for example applied to the outer sheet 2.1, 2.2 with a layer thickness of between 5 and 25 μm, preferably between 8 and 15 μm. The adhesive may for example be applied by spraying, knife application or by means of applicator rollers. The connecting of the outer layers 2.1, 2.2 and the core layer 2.3 is then preferably performed by means of a heated double belt press (not shown), in which the adhesive is activated by pressure and temperature and is crosslinked with the fibre-containing, temperature-resistant core layer 2.3.

The core layer 2.3 is preferably encapsulated in the material composite 2 by the adhesive and/or the outer sheets 2.1, 2.2 against the ingress of moisture.

The composite material 2 according to the invention is well-suited for undergoing plastic deformation, in particular by deep drawing and/or stamping. For this purpose, for example, blanks are cut off from a corresponding composite material 2 in strip form and formed into three-dimensional roofing elements 1, 1′ in a forming press (not shown). The roofing elements 1, 1′ can in this case be produced in virtually any desired forms or profiles and in various dimensions.

As shown in FIGS. 2a to 2c and 3, the component 1, 1′ according to the invention may for example have a corrugated form, in particular the form of pantiles. The respective component 1, 1′ according to the invention is in this case preferably considerably larger than a “normal” pantile, which consists of concrete or fired clay material. The dimensions of the component 1, 1′ according to the invention may for example be the length of 3 to 10 “normal” concrete or clay pantiles arranged next to one another and/or one on top of the other. The dimensions of a component 1, 1′ according to the invention may thus for example be of the order of magnitude of 1 m×2 m.

Furthermore, the component 1 according to the invention may have at least one fold 1.1. The fold may in this case be arranged in such a way that it allows the component 1 or 1′ to be hung in a form-fitting manner on a substantially horizontally running batten. Alternatively or in addition, the component 1, 1′ according to the invention may also have a fold 1.1 running with the roof pitch, so that with the component 1 the so-called verge, i.e. the lateral termination of the roof area at a vertical gable, can be produced (cf. FIGS. 2a and 2c). In this case, an impressions and/or recess 1.2 is preferably provided at the fold 1.1, in order to achieve at the verge an edge surface that is as flush as possible.

In FIG. 4, a roof of a building that is covered with components 1 according to the invention, for example the roof of an industrial building 3, is shown drafted, a photovoltaic system 4 being mounted on the roof skin.

The design of the invention is not restricted to the exemplary embodiments that are presented in the drawing. Rather, numerous variants of the component according to the invention (roofing element) 1, 1′ that make use of the invention specified in the accompanying claims, even in the case of configurations that differ from the exemplary embodiments presented, are conceivable.

1.-16. (canceled)

17. A roof covering element, comprising:
at least one core layer of a fibre-containing insulating material that is configured to resist temperatures of at least 600° C. and has a thickness of up to 2.0 mm;
a first metallic outer sheet disposed on a first side of said at least one core layer; and
a second metallic outer sheet disposed on a second side of said at least one core layer, which second side opposes said first side, so as to form a sandwich-structure material composite.

18. The roof element of claim 17, wherein the thickness of said at least one core layer is at least 1.5 times the thickness of one of said first or second metallic outer layers.

19. The roof element of claim 17, wherein the insulating material of said at least one core layer has a thickness between about 0.6 mm to about 1.5 mm.

20. The roof element of claim 17, wherein the insulating material of said core layer comprises inorganic fibres, inorganic fillers, organic fibres, and a binder.

21. The roof element of claim 17, wherein said first and second metallic outer sheets are made from steel.

22. The roof element of claim 17, wherein said first and second metallic outer sheets comprise a corrosion resistant protective layer.

23. The roof element of claim 17, wherein said first and second metallic outer sheets each have a thickness between about 0.1 mm to about 0.8 mm.

24. The roof element of claim 17, wherein said first metallic outer sheet has a first thickness and a comprises a first corrosion resistant protective layer disposed thereon, and wherein said second metallic outer sheet has a second thickness different from said first thickness and comprises a second corrosion resistant protective layer disposed thereon that is different from said first corrosion resistant protective layer.

25. The roof element of claim 17, wherein at least one of said first and second metallic outer sheets comprise a corrosion resistant protective layer of zinc.

26. The roof element of claim 17, wherein at least one of said first and second metallic outer sheets comprise a corrosion resistant protective layer of aluminum.

27. The roof element of claim 17, wherein one of said first and said second metallic outer sheets is an upper outer sheet configured to be exposed to environmental elements, and wherein an outer surface of the upper outer sheet is a corrosion resistant protective layer of aluminum.

28. The roof element of claim 17, wherein said first and second metallic outer sheets are respectively coupled to said at least one core layer by respective first and second adhesive layers disposed there between.

29. The roof element of claim 28, wherein the adhesive from said first and second adhesive layers is a water-based adhesive.

30. The roof element of claim 28, wherein said first and second adhesive layers each have a thickness of between about 5 μm to 25 μm.

31. The roof element of claim 17, wherein said sandwich-structured material composite roof element has one of a corrugated or trapezoidal cross sectional shape.

32. The roof element of claim 31, wherein said sandwich-structured material composite roof element is formed as one of a pantile or shingle.

33. The roof element of claim 17, wherein said sandwich-structured material composite roof element has at least one fold formed therein.
